(19) United States
(12) Patent Application Publication
(10) Pub. No.: US 2019/0378057 A1
(43) Pub. Date: Dec. 12, 2019

(54) SOCIAL NETWORK-BASED TRAVEL SYSTEMS AND METHODS

(71) Applicant: SUSSII PTY LTD, Prahan (AU)

(72) Inventor: Toby ARMSTRONG, Prahran (AU)

(21) Appl. No.: 16/479,100

(22) PCT Filed: Jan. 18, 2018
(86) PCT No.: PCT/AU2018/050032

§ 371 Date: Jul. 18, 2019

(30) Foreign Application Priority Data
Jan. 20, 2017 (AU) 2017900184
May 17, 2017 (AU) 2017901847

(51) Int. Cl. G06Q 10/02; G06Q 50/00

(52) U.S. Cl. CPC G06Q 10/02; G06Q 50/01

(57) ABSTRACT

A method, comprising: receiving, by a processor, one or more of past, present, future, and planned locations of travellers within a social network, together with associated temporal data; generating, by a or the processor, an interactive spatial visualisation of the locations of the travellers; generating, by a or the processor, an interactive temporal visualisation of the temporal data; and displaying the spatial and temporal visualisations on a user device; wherein the spatial and temporal visualisations are synchronised such that user interaction of the temporal visualisation via the user device is reflected in corresponding changes in the spatial visualisation displayed.

### FIELD

The present invention relates to social network-based travel systems and methods.

### BACKGROUND

Conventional travel booking web and mobile applications such as TripAdvisor allow users to search for and book travel-related services, and may include customer reviews to assist with selection of these services. However, the anonymous reviews may not be particularly relevant or trustworthy to the user. This is further exacerbated by the increase in fraudulent reviews on booking websites.

Conventional travel planning web and mobile applications such as TripIt allow users to plan trip itineraries and share these with friends. However, the creation of the trip itinerary itself is mainly an independent process, with no integration with or input from the user's friends. In some cases, the user is not aware that their friends have been to or will be travelling to same travel destination, and so misses the chance to ask for advice or to meet up with their friends when travelling.

Conventional airfare metasearch engines such as Skyscanner allow users to simultaneously search and compare inventory from multiple airline websites. While this provides time and cost savings to the user when planning a single flight, there still remains a need for a tool to assist the user with the much more challenging and time consuming task of planning an entire trip that includes multiple stopovers, accommodation and sightseeing activities.

In this context, there is a need for social network-based systems and methods to assist travellers with exploring trip ideas, planning a trip, and while travelling with a group.

### SUMMARY

According to the present invention, there is provided a method, comprising:

receiving, by a processor, one or more of past, present, future, and planned locations of travellers within a social network, together with associated temporal data;

generating, by a or the processor, an interactive spatial visualisation of the locations of the travellers;

generating, by a or the processor, an interactive temporal visualisation of the temporal data; and

displaying the spatial and temporal visualisations on a user device;

wherein the spatial and temporal visualisations are synchronised such that user interaction of the temporal visualisation via the user device is reflected in corresponding changes in the spatial visualisation displayed.

The spatial visualisation may be a map and the location of each traveller may be represented by a marker on the map.

The spatial visualisation may be a map and the number of travellers at a common location may be represented by a marker on the map.

The temporal visualisation may be a timeline, and the user may interact with the temporal visualisation by selecting a time point on the timeline.

The user may select the time point by clicking on, tapping on, hovering on, or moving a slider element to the time point.

The temporal visualisation may further comprise visual representation of the amount of travel activity at one or more time points.

User interaction of the spatial visualisation may comprise one or more of zooming into the map, searching the map for a specific region or traveller, selecting a specific region or traveller to view additional information, and bookmarking a specific region.

The present invention also provides a method comprising:

receiving, by a processor, one or more of past, present, future, and planned locations of travellers within a social network, together with associated temporal data;

generating, by a or the processor, a Gantt chart visualisation of travel activity and/or locations of all the travellers within the social network across a specific time period; and

displaying the Gantt chart visualisation on a user device;

wherein each traveller is represented by a line of the Gantt chart and the time-varying travel activity and/or locations of the traveller are represented by markers on the line.

The method may further comprise:

generating, by a or the processor, a spatial visualisation of the locations of the travellers; and

displaying the spatial visualisation on the user device.

The spatial visualisation may be a map and the locations and movement of each traveller may be represented on the map by markers and arrows or lines respectively.

The method may further comprise:

generating, by a or the processor, a spatial visualisation of the locations of the travellers; and

displaying the spatial visualisation on a user device;

wherein the spatial visualisation is synchronised with the Gantt chart visualisation such that user interaction of the Gantt chart visualisation via the user device is reflected in corresponding changes in the spatial visualisation displayed.

The user may interact with the Gantt chart visualisation by clicking on, tapping on, hovering on, or moving a slider element to a time point to select the time point.

The spatial visualisation may be a map and the location of each traveller may be represented by a marker on the map.

The user device may comprise a computer, a laptop, a tablet or a smartphone.

The method may further comprise:

generating, by a or the processor, an interactive leaderboard visualisation of the travellers ranked by number of past locations of each traveller,

displaying the leaderboard visualisation on the user device.

User selection of a traveller displayed on the leaderboard visualisation may generate a spatial and/or temporal visualisation display of the locations of the selected traveller.

The present invention also provides a system, comprising:

a processor;

a memory coupled to the processor; and

instructions stored in the memory that, when executed by the processor, cause the processor to:

receive one or more of past, present, future, and planned locations of travellers within a social network, together with associated temporal data;

generate an interactive spatial visualisation of the locations of the travellers,

generate an interactive temporal visualisation of the temporal data; and

display, on a user device, the spatial and temporal visualisations;

wherein the spatial and temporal visualisations are synchronised such that user interaction of the temporal visualisation via the user device is reflected in corresponding changes in the spatial visualisation displayed.

The present invention also provides a system, comprising:

a processor;

a memory coupled to the processor; and

instructions stored in the memory that, when executed by the processor, cause the processor to:

receive one or more of past, present, future, and planned locations of travellers within a social network, together with associated temporal data;

generate a Gantt chart visualisation of travel activity and/or locations of all the travellers within the social network across a specific time period; and

display, on a user device, the Gantt chart visualisation;

wherein each traveller is represented by a line of the Gantt chart and the time-varying travel activity and/or locations of the traveller are represented by markers on the line.

The present invention also provides a computer program product comprising computer executable program code recorded on a computer readable non-transitory storage medium, the computer executable program code comprising:

code for receiving one or more of past, present, future, and planned locations of travellers within a social network, together with associated temporal data;

code for generating an interactive spatial visualisation of the locations of the travellers;

code for generating an interactive temporal visualisation of the temporal data; and

code for displaying, on a user device, the spatial and temporal visualisations;

wherein the spatial and temporal visualisations are synchronised such that user interaction of the temporal visualisation via the user device is reflected in corresponding changes in the spatial visualisation displayed.

The present invention also provides a computer program product comprising computer executable program code recorded on a computer readable non-transitory storage medium, the computer executable program code comprising:

code for receiving one or more of past, present, future, and planned locations of travellers within a social network, together with associated temporal data;

code for generating a Gantt chart visualisation of travel activity and/or locations of all the travellers within the social network across a specific time period; and

code for generating an interactive temporal visualisation of the temporal data; and

code for displaying, on a user device, the Gantt chart visualisation;

wherein each traveller is represented by a line of the Gantt chart and the time-varying travel activity and/or locations of the traveller are represented by markers on the line.

The present invention also provides a method, comprising:

receiving, at a processor, a planned trip itinerary of a user comprising one or more trip segments;

computing, by the processor, costs for each trip segment comprising one or more user-shortlisted transportation, accommodation, and sightseeing components, wherein the user-shortlisted costs reflect real-time prices;

computing, by the processor, total cost for the entire trip comprising the sum of trip segment costs;

generating, by the processor, a timeline visualisation of the planned trip itinerary comprising trip segment costs and total trip cost; and

displaying the timeline visualisation on a user device.

The timeline visualisation may further comprise a user interface control to book one or more user-shortlisted transportation, accommodation, and sightseeing components.

The timeline visualisation may further comprise a user interface control to book all the user-shortlisted transportation, accommodation, and sightseeing components for a trip segment.

The timeline visualisation may further comprise a user interface control to book all the user-shortlisted transportation, accommodation, and sightseeing components for the entire trip.

Selecting a user interface control may redirect the user to a booking webpage for each of the relevant transportation, accommodation, and sightseeing components.

The method may further comprise:

updating, by the processor, costs for each of the user-shortlisted transportation, accommodation, and sightseeing components based on real-time prices obtained by the processor,

transmitting a notification to the user device when the real-time price of one or more of: a user-shortlisted transportation component, a user-shortlisted accommodation component, a user-shortlisted sightseeing component, a trip segment, and an entire trip, is at or below a user-selected threshold price.

The timeline visualisation may further comprise user interface controls to add, modify and delete one or more of: a user-shortlisted transportation component, a user-shortlisted accommodation component, a user-shortlisted sightseeing component, a trip segment, and an entire trip, and wherein the timeline visualisation is updated to reflect said changes.

The method may further comprise:

obtaining, by the processor, alternative option(s) to one or more of the user-shortlisted transportation, accommodation, and sightseeing components,

displaying, on the timeline visualisation, the alternative options and associated costs.

The alternative options may comprise one or more of alternative dates, alternative times, and alternative providers to the user-shortlisted components.

The method may further comprise computing, by the processor, optimised trip segment(s) comprising one or more alternative options resulting in lower trip segment cost(s) compared to the user-shortlisted trip segment.

The timeline visualisation may further comprise a user interface control to book one or more of the alternative options.

The present invention also provides a system, comprising:

a processor;

a memory coupled to the processor; and

instructions stored in the memory that, when executed by the processor, cause the processor to:
receive, at a processor, a planned trip itinerary of a user comprising one or more trip segments;
compute, by the processor, costs for each trip segment comprising one or more user-shortlisted transportation, accommodation, and sightseeing components, wherein the user-shortlisted costs reflect real-time prices;
compute, by the processor, cost for the entire trip comprising the sum of trip segment costs;
generate, by the processor, a timeline visualisation of the planned trip itinerary comprising trip segment costs and total trip cost; and
display the timeline visualisation on a user device.

The present invention also provides a computer program product comprising computer executable program code recorded on a computer readable non-transitory storage medium, the computer executable program code comprising:

code for receiving a planned trip itinerary of a user comprising one or more trip segments;

code for computing costs for each trip segment comprising one or more user-shortlisted transportation, accommodation, and sightseeing components, wherein the user-shortlisted costs reflect real-time prices;

code for computing total cost for the entire trip comprising the sum of trip segment costs;

code for generating a timeline visualisation of the planned trip itinerary comprising trip segment costs and total trip cost; and

code for displaying the timeline visualisation on a user device.

### BRIEF DESCRIPTION OF DRAWINGS

Embodiments of the invention will now be described by way of example only with reference to the accompanying drawings, in which:

FIG. 1 is a block diagram of a social network-based system according to an embodiment of the present invention;

FIG. 2 is a flow chart illustrating the social network-based system and associated method steps;

FIGS. 3a to 3f are screenshots of one example of the method for social travel exploring;

FIGS. 4a to 4c are screenshots of one example of the method for adding a trip;

FIGS. 5a to 5g are screenshots of one example of a trip module compiled using the social network-based travel system and method;

FIG. 6 is a screenshot of one example of an itinerary timeline visualisation for planning a trip;

FIG. 7 is a screenshot of one example of an interactive leaderboard for social travel exploring; and

FIG. 8 is a screenshot of one example of a search screen for social travel exploring.

### DESCRIPTION OF EMBODIMENTS

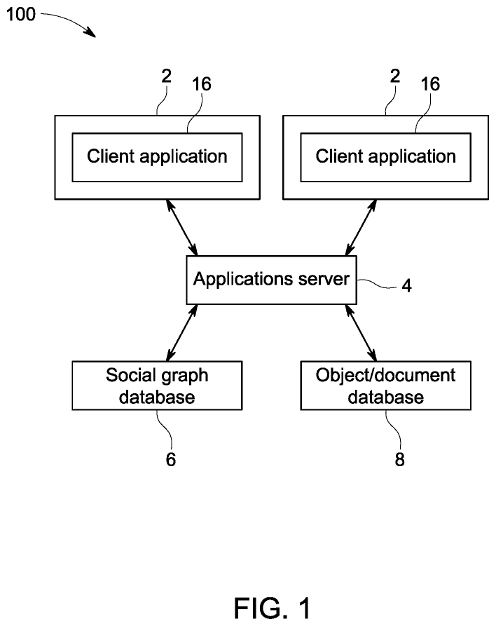

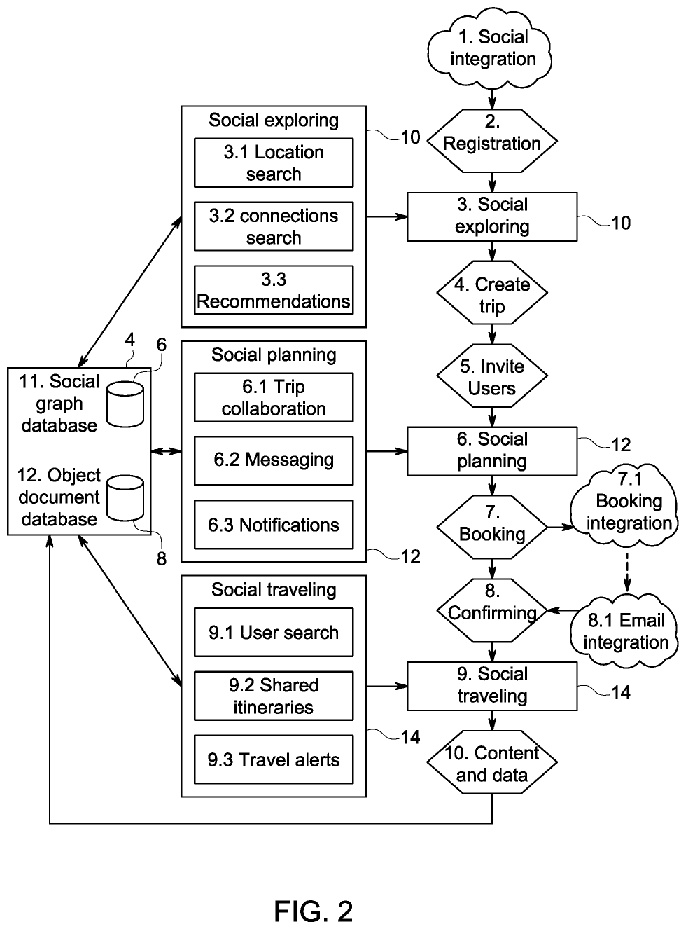

FIG. 1 illustrates one embodiment of the social network-based system 100 for travellers and FIG. 2 illustrates the associated method steps that may be implemented by and/or on one or more specially programmed computing devices of the system 100. The specially programmed computing devices of the system 100 may comprise user devices 2 connected to one or more application servers 4 associated with one or more databases 6, 8 through a data communication network, eg, local area network (LAN) or wide area network (WAN), eg, the Internet, or a combination of networks, any of which may include wireless links. The application server 4 and associated databases 6, 8 may comprise a cloud server, cloud data storage, and combinations thereof.

The user interacts with the system 100 via a client application 12, such as a web application or mobile application, running on the user device 2. The user device 2 may be used to receive input from the user and display results to the user. The user device 2 may generally include a memory for storing instructions and data, and a processor for executing stored instructions. The memory may include both read only and writable memory. For example, the user device 2 may be a mobile device such as a computer, laptop, smartphone or tablet.

All users of the social network-based system 100 are connected to the application server 4 through the data communication network, thereby allowing data to be shared within groups of users depending on access permissions. Data about each user, together with their relationships with and access permissions to other users of the system, may be stored in social graph database 10. Access permissions may be user-specified (eg family only) or may be based on degrees of separation from the user. For succinctness, the members of the travel social network that the user has access to will be referred to as the user's “friends” in this specification.

The system 100 may also be integrated with third-party applications, eg social network applications such as Facebook and LinkedIn, and email providers such as Gmail and Outlook. In some embodiments, the system 100 may sync and share information with third-party email and calendar applications running on the user device 2. The system 100 may also communicate with third-party providers such as transportation and accommodation providers to allow the user to search and/or book travel-related services. For example, the client application may be integrated with e-commerce applications such as online booking applications and online ticketing applications to facilitate reservations directly via the system 100.

In preferred embodiments, one or more third-party applications may be used as authentication providers for users to access system 100. In some embodiments, the system 100 may additionally import existing social networks from the third-party application, for example via email contacts or via application programming interfaces (API) linking the client application with the third-party application. In some embodiments, when registering for an account with the travel social network, the user is asked to provide access permissions to all of the user's friends from one or more third-party social network applications. Accordingly, whether via third-party application integration or solely via the travel social network of the present system 100, registered users will have the ability to find and connect with their friends through a secured network that is transparent within the specified group of the user's friends.

This secured network transparency importantly allows for improved methods for providing travel inspiration and recommendations to users via a social exploring module 10, improved methods for planning a trip via a social planning module 12, and/or improved methods for organising travel companions during a trip via a social travelling module 14. The user is able to view travel activity within their network of friends when searching for travel ideas or planning a trip, thereby allowing them to easily coordinate their trips to coincide with friends' locations. In some embodiments, the user can view reviews and/or obtain recommendations from friends whose past locations coincide with the user's planned destinations. Recommendations received from the user's social network are likely to be more relevant and more reliable, compared to third-party reviews.

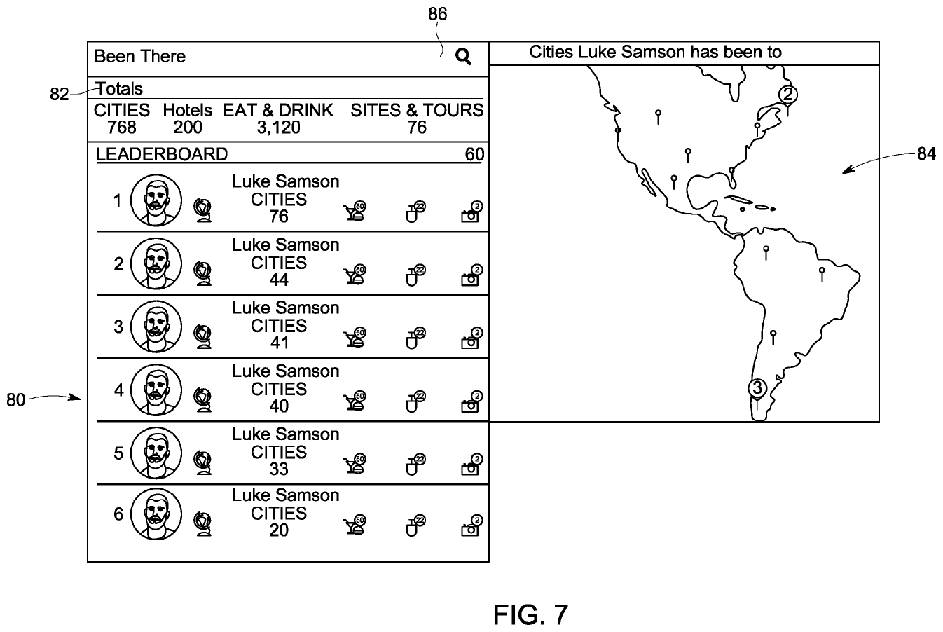

In some embodiments, the social network-based system 100 may include features for enhancing social interaction such as a leaderboard 80 as illustrated in FIG. 7. The leaderboard 80 may be an interactive visualisation generated by the processor, which ranks all of the user's friends by the number of past locations of each traveller, ie by how well-travelled each traveller is. Accordingly, the leaderboard may increase competition between users of the system, to inspire more travel activities. The leaderboard 80 may be displayed on the user device 2, and may be integrated with the social exploring module 10. The total past locations 82 of the user's friends may be displayed at the top of the leaderboard 80. The user may also search for their friends on the leaderboard via user interface control 86..

User selection of a traveller displayed on the leaderboard visualisation may generate a spatial and/or temporal visualisation display 84 of the past locations of the selected traveller. Examples of spatial and/or temporal visualisations suitable for display 84 will be described in more detail below.

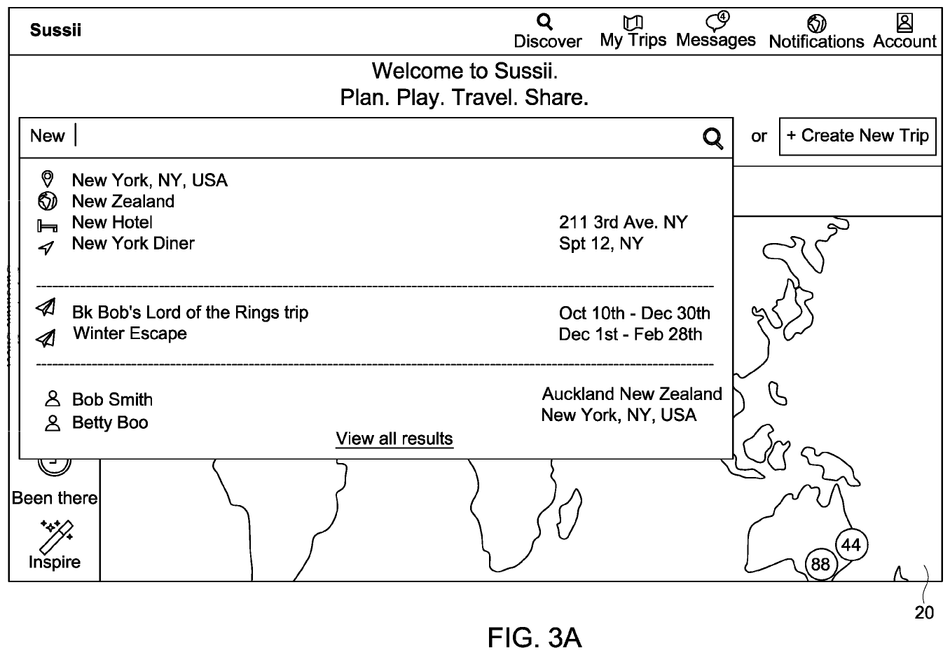

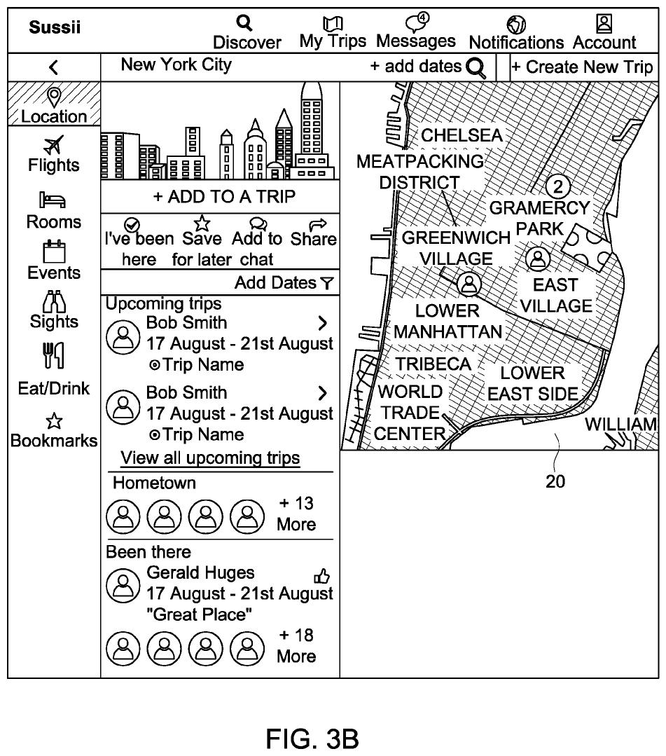

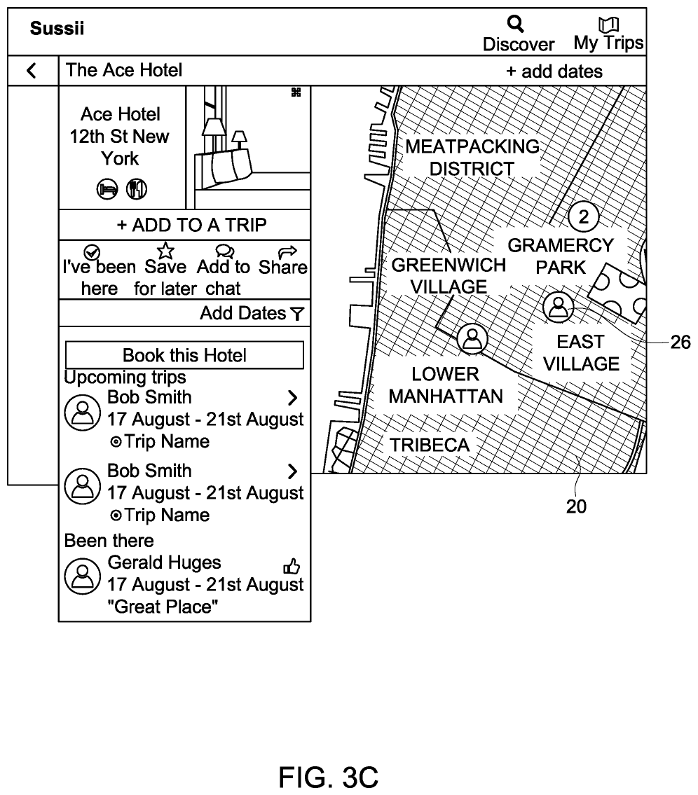

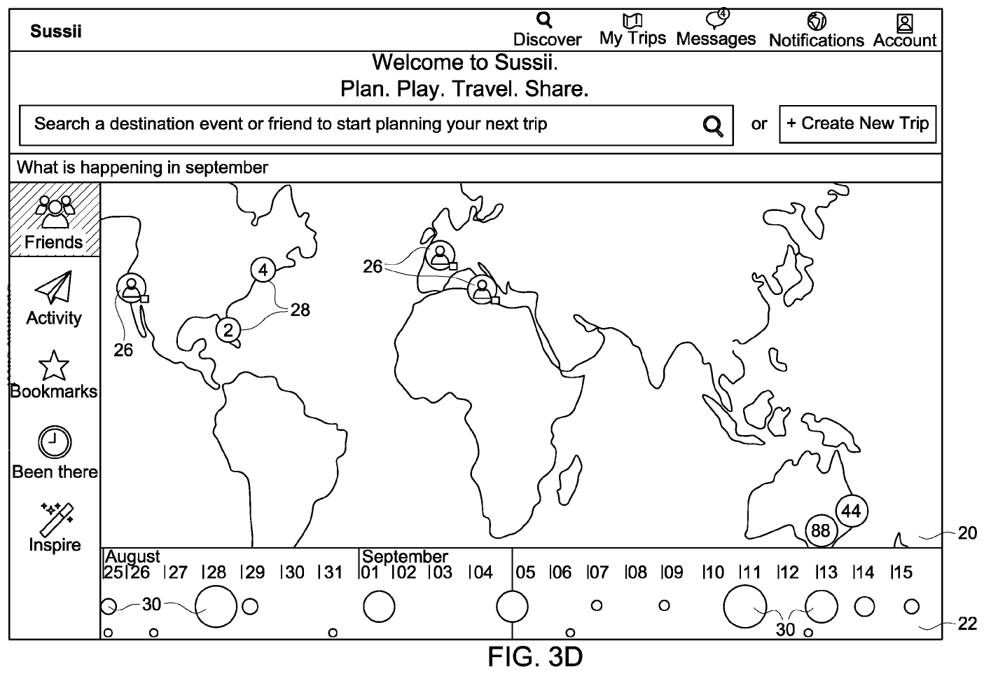

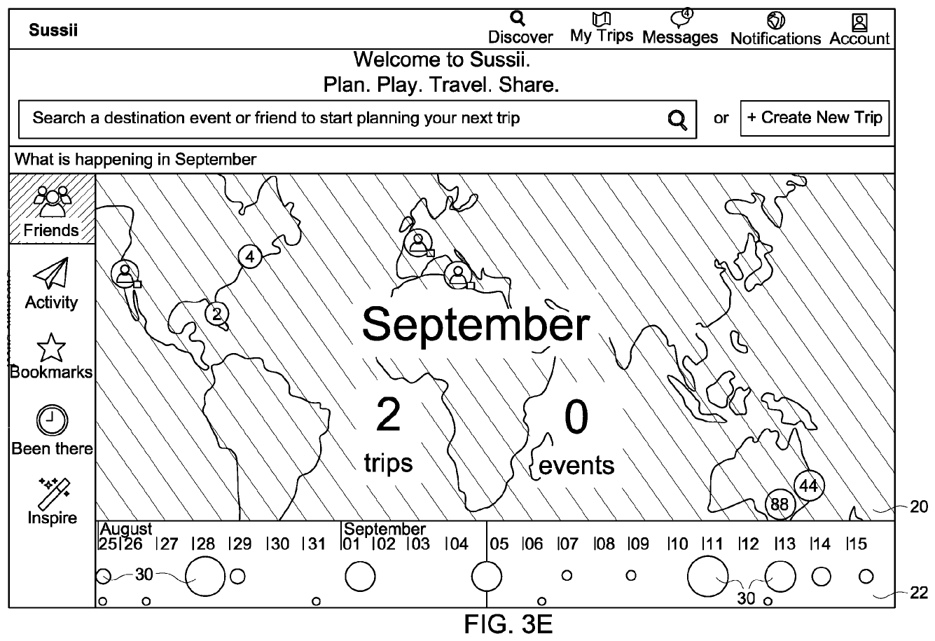

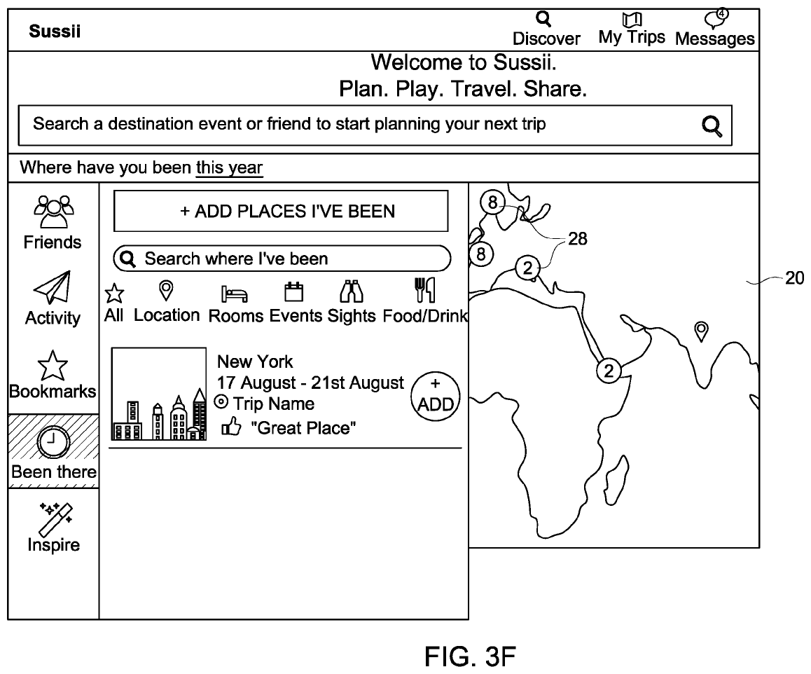

Specifically, in preferred embodiments, a processor of the server 4 receives location data of the members of a user's social network. The location data may comprise past, present, future, and planned locations of the users, together with the associated temporal data. The location data may be compiled and updated over time. The processor of the server 4 or a processor of the user device 2 may generate an interactive spatial visualisation 20 of the locations of the travellers, as illustrated in FIGS. 3a to 3f. The processor of the server 4 or the processor of the user device 2 may also generate an interactive temporal visualisation 22 of the temporal data. The spatial visualisation 20 and temporal visualisation 22 may be displayed on the user device 2 and are synchronised such that user interaction of the temporal visualisation 22 via the user device 2 is reflected in corresponding changes in the spatial visualisation 20 displayed.

The synchronisation between the temporal and spatial visualisations provides a convenient tool for users to search for and obtain a comprehensive view of time-varying travel activity within the user's social network. The synchronised temporal and spatial visualisations may be displayed to the user when using any one of the social exploring module 10, the social planning module 12 and the social travelling module 14.

In some embodiments, the spatial visualisation 20 is a dynamic map, and the location of each traveller may be represented by a marker on the map. Additionally or alternatively, the number of travellers at a common location may be represented by a marker on the map. For example, as shown in FIG. 3e, when the user selects “September” from the temporal visualisation 22, the location markers 26 and activity markers 28 on map 20 are updated to reflect the locations of the user's friends in September.

In some embodiments, the user may interact with the spatial visualisation 20 by zooming into the map to obtain a more detailed view of a particular region (as shown in FIGS. 3b and 3c), by searching the map for a specific region or traveller (as shown in FIG. 3a), by selecting a particular region or traveller to view additional information such as the traveller's profile information, history of trips 32, wishlist, reviews, etc, or by selecting a specific region or accommodation for bookmarking or booking. Additional or alternative spatial visualisations may be employed, for example pie charts, bar graphs, heat maps, etc.

In some embodiments, the spatial and temporal visualisations may reflect trip suggestions, travel ideas, or “instant” templated trips, with markers on the map to reflect suggested destinations, hotels, activities or other travel data that is interactive and dynamic to reflect temporal user interactions. A whole packaged trip or “Quicktrip” suggestion may be presented to the user based on, for example, popular time and/or event-based travel, such as a trip to Germany for Oktoberfest, or ski trips during a snow season at the appropriate locations. The “Quicktrip” suggestion may therefore allow the user to quickly and conveniently plan an entire trip (or segment of a trip). In some embodiments, the user is able to modify one or more items within the “Quicktrip”, eg swap a suggested hotel, lengthen the suggested trip, etc., preferably by interacting with the spatial and/or temporal visualisations. The suggestions may additionally or alternatively be based on one or more of the user's friend's past or planned travel itineraries.

In some embodiments, the temporal visualisation 22 is a timeline, as illustrated in FIGS. 3d and 3e. The user may interact with the temporal visualisation by selecting a time point or time range on the timeline, for example by clicking on, tapping on, hovering on, or moving a slider element to the time point. In other embodiments, the user may interact with the temporal visualisation 22 by entering a specific time point or range into a search box, or by clicking a date in a calendar display.

In some embodiments, the temporal visualisation 22 may further comprise visual representation of the amount of travel activity during one or more time points, for example as indicated by the size of activity markers 30 on temporal visualisation 22. Alternatively, the user may view travel statistics of a particular time point (eg in a pop-up box) by selecting or hovering on the time point. Additional or alternative temporal visualisations may be employed, for example, calendars, time tables, Gantt charts, etc.

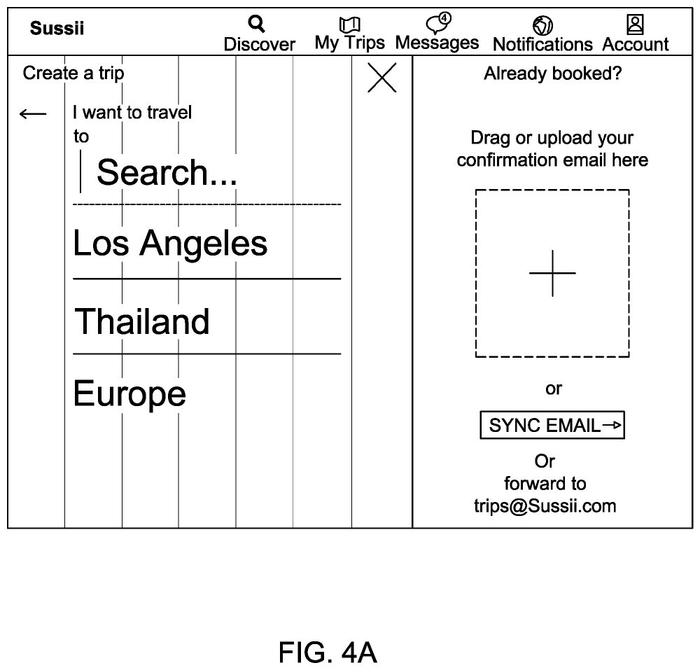

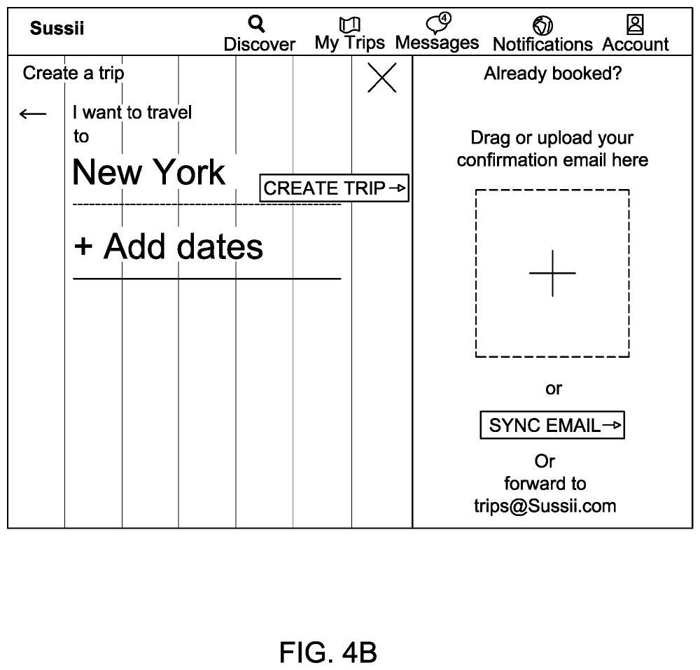

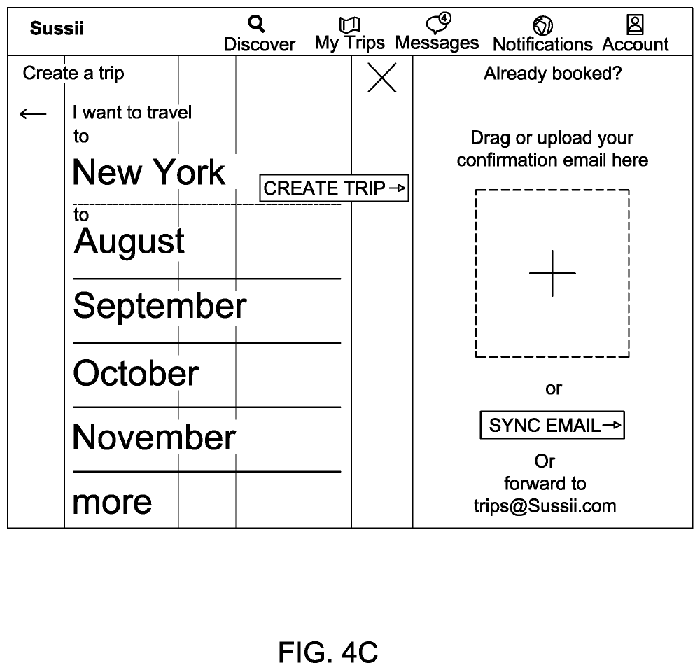

The location data of the members of the social network may be received at server 4 by various methods. For example, the locations may be manually entered by the user. As shown in FIGS. 4a to 4c, the user may enter planned locations by manually creating a trip or by uploading a booking confirmation document. Other means of obtaining a user's location include geolocation of the user device 2, clickstream analysis, etc. Location data and other related information may be stored in object/ document database 8 associated with applications server 4. In preferred embodiments, the locations of users may be updated substantially in real time.

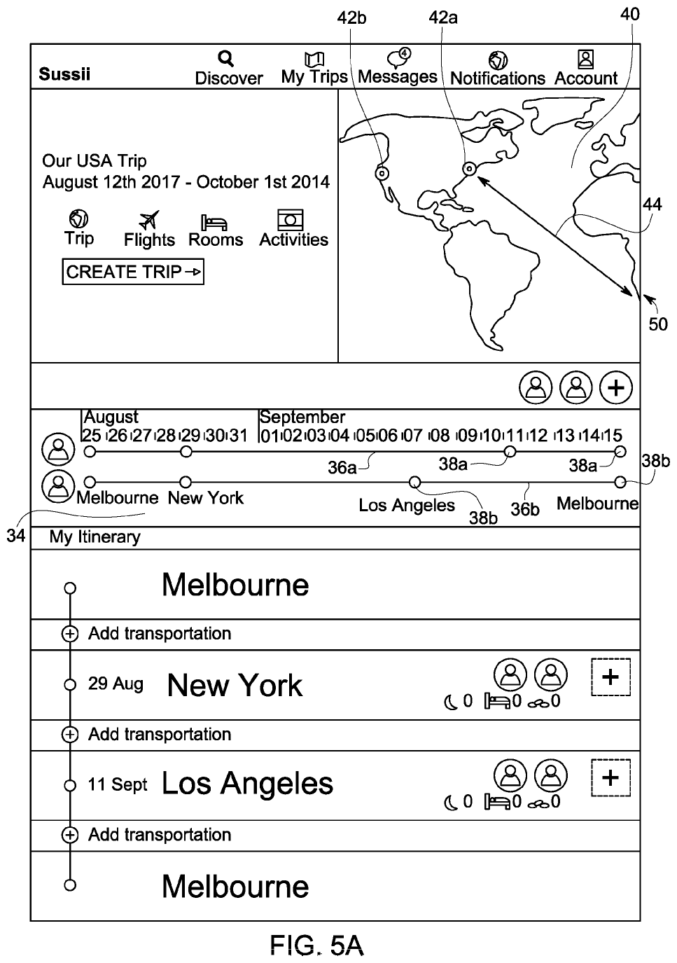

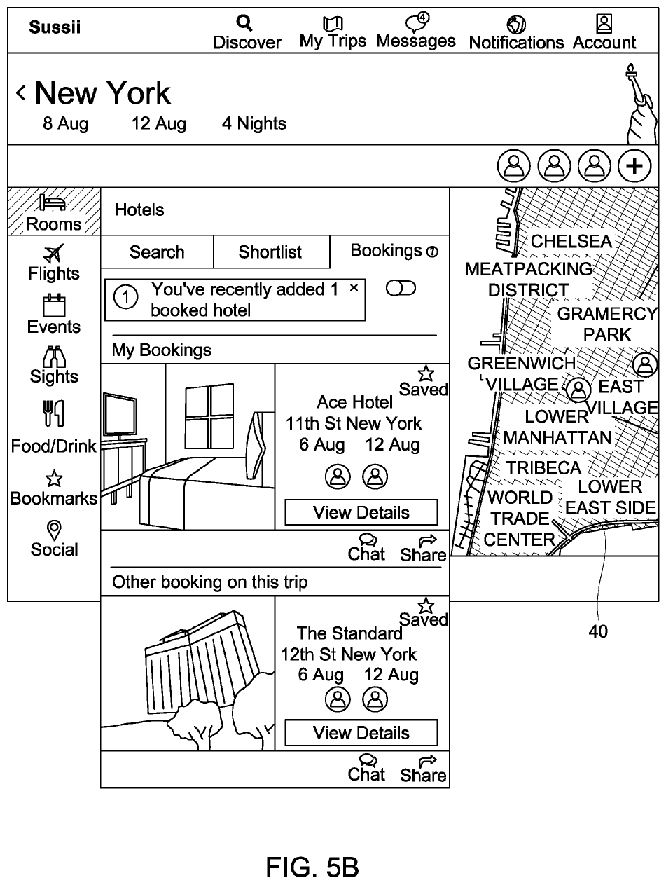

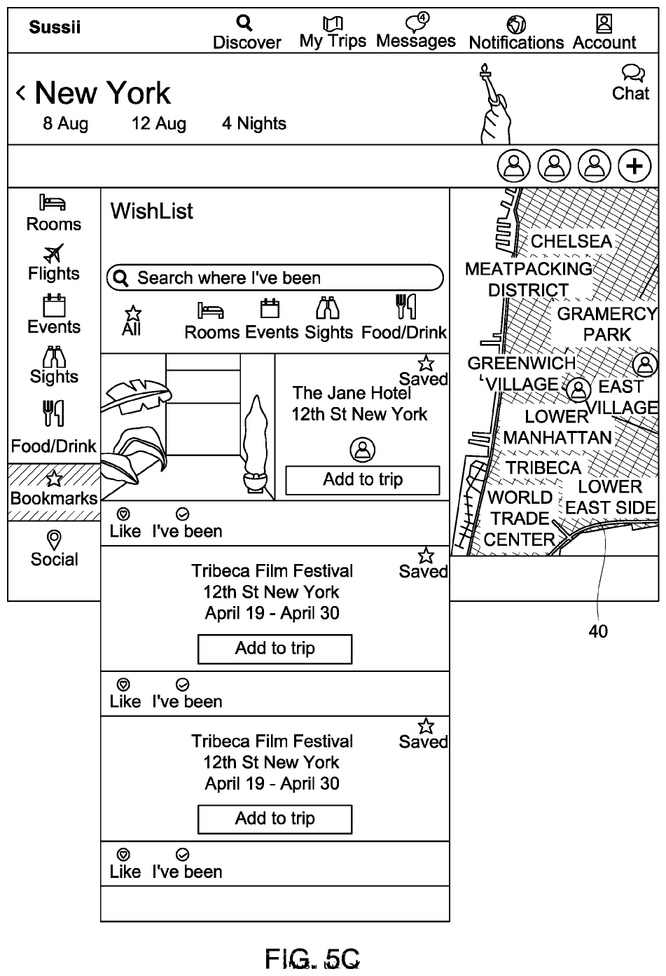

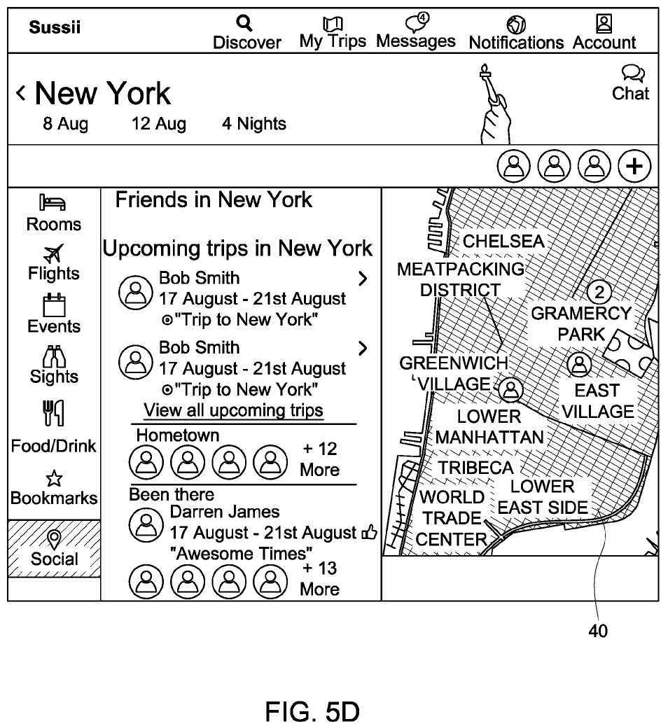

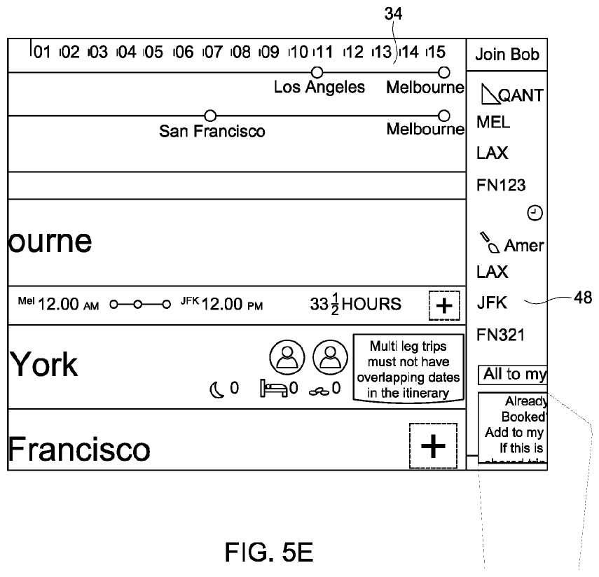

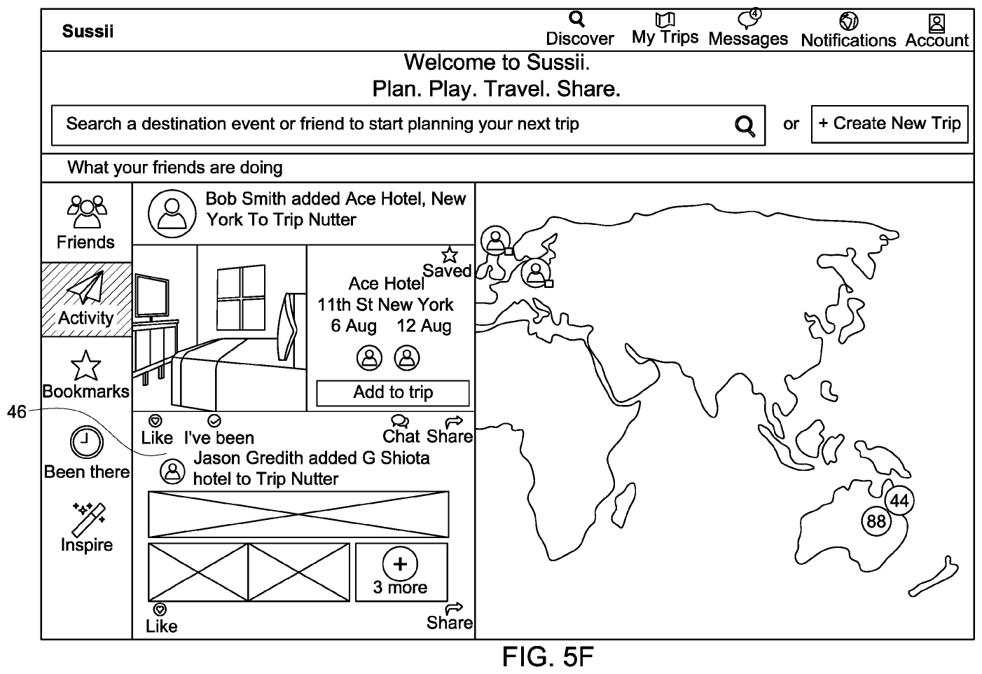

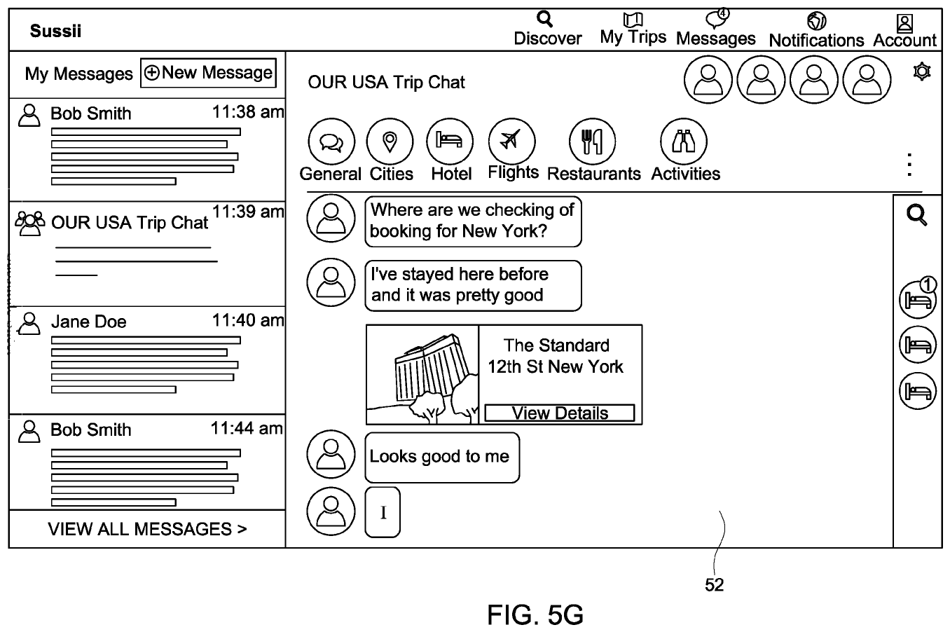

In another embodiment, after the processor of the server 4 receives location data of the members of a user's social network as described above, the processor of the server 4 or the processor of the user device 2 may generate a Gantt chart visualisation of travel activity and/or locations of the travellers within the social network across a specific time period. As illustrated in FIG. 5a, the Gantt chart 34 may be displayed on the user device 2. In a preferred embodiment, each traveller is represented by a line 36a, 36b of the Gantt chart and the time-varying locations of each traveller are represented by markers 38a, 38b on each line.

The Gantt chart visualisation 34 may be displayed to the user when using any one of the social exploring module 10, the social planning module 12 and the social travelling module 14. It allows users to view, at a single glance, overlapping and diverging locations of members of the group, and may be particularly useful for planning a trip for the group. Additionally, the Gantt chart 34 facilitates monitoring movement of members of the group and organising rendezvous points during a trip. In other embodiments, markers on the Gantt chart may instead represent travel activity of each member (ie whether or not the member is travelling at a particular time), and may be particularly useful for facilitating the initial stages of trip planning.

In some embodiments, the processor of the server 4 or the processor of the user device 2 may also generate a spatial visualisation of the locations of the travellers, for display on the user device 2. For example, as illustrated in FIG. 5a, the spatial visualisation 40 may be a map, and the locations and movement of each traveller may be represented on the map by markers 42a, 42b and arrows or lines 44 respectively. In this example, the spatial visualisation 40 is a static map, yet provides a comprehensive overview of the movements of travellers in the group.

In other embodiments, similar to the synchronised temporal and spatial visualisations described above, the spatial visualisation 40 may be dynamically synchronised with the Gantt chart visualisation 34 such that user interaction of the Gantt chart via the user device 2 is reflected in corresponding changes in the spatial visualisation 40 displayed. The user may interact with the Gantt chart 34 by clicking on, tapping on, hovering on, or moving a slider element to a time point to select the time point. Alternatively, the user may interact with the Gantt chart 34 by entering a specific time point or range into a search box, or by clicking a date in a calendar display.

The spatial visualisation 40 may additionally allow user-interaction. For example, the user may be able to zoom into the map to obtain a more detailed view of a particular region (as shown in FIGS. 5b and 5c), select a particular region to view additional information such as bookings 42, wishlist items 44, friends in the area 46, etc, select a traveller to view additional information such as the traveller's profile information, history of trips, wishlist, reviews, travel activity, etc, or select a specific region or accommodation for bookmarking or booking.

To facilitate creation of a trip, information such as booking confirmations may be received from each member of the group by server 4, and compiled into a trip module 50 that is accessible by all members of the group. In some embodiments, trip details such as booked flights 48 may be shared or recommended between members, allowing a group coordinator to add the details to the trip module 50, and/or allowing other members of the group to book the same service. Members of the group may also be able to communicate with each other within a dedicated chat group 52 via user device 2, as illustrated in FIG. 5g.

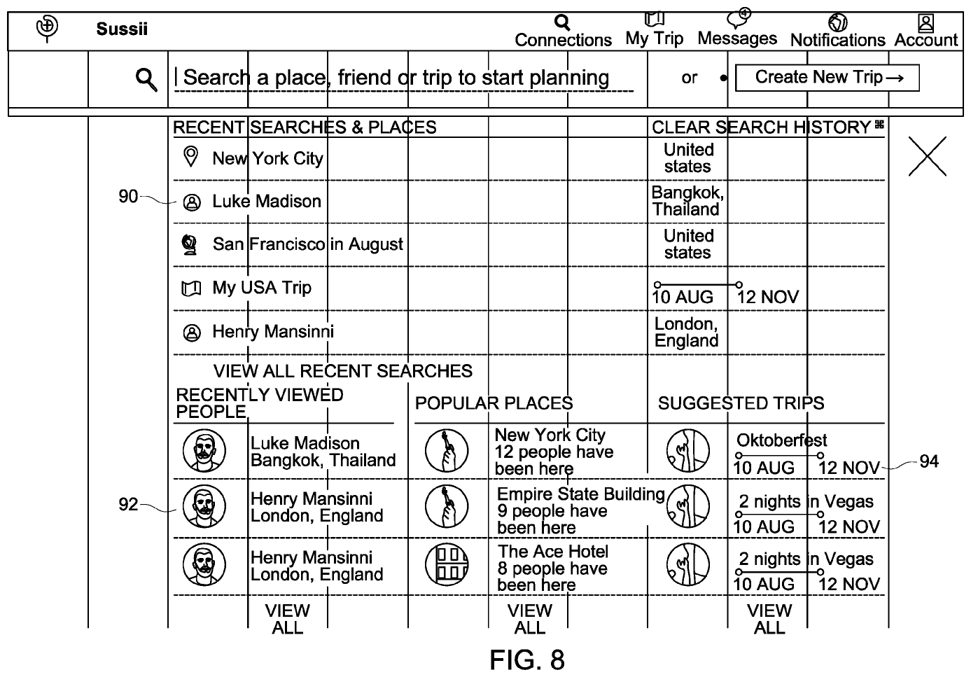

As described above, the user may be able to search for travel ideas (eg by searching places, people or trips) and the search results may include travel activity within the user's network of friends, thereby allowing the user to easily coordinate their trips to coincide with friends' locations. The search functionality may also save recent search strings 90 and recent search results 92, as illustrated in FIG. 8. In some embodiments, the search results may also include suggestions 94 comprising, for example, popular places that the user's friends or other users have been to or searched for, relevant advertisements or sponsored suggestions relating to the user's search.

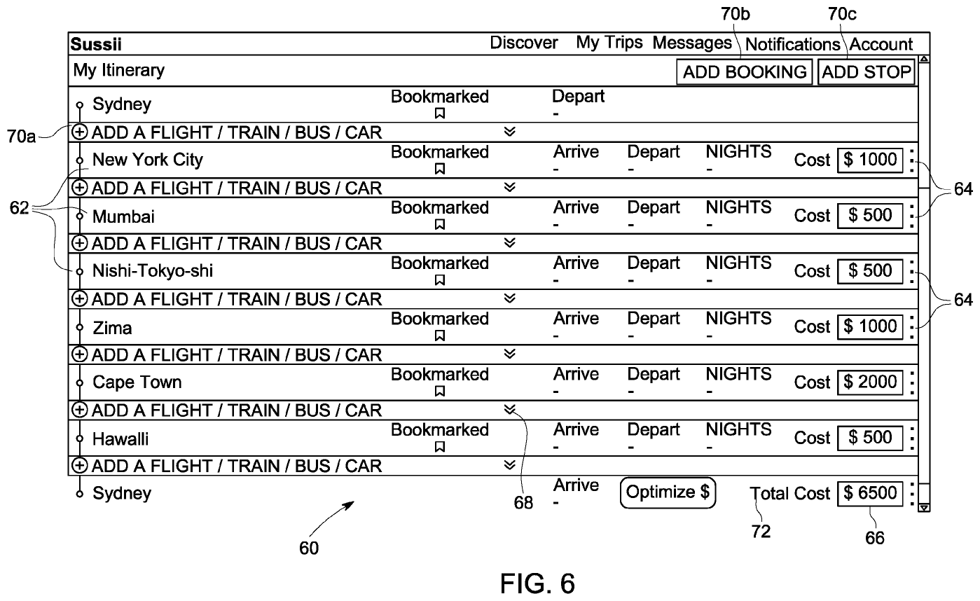

To assist a user with planning a trip, the present system and method may include trip watch functionality, as illustrated in FIG. 6. The trip watch method may comprise receiving, at a processor of the server 4, a user's planned trip itinerary. The itinerary may comprise one or more trip segments, each typically associated with different city or country in a multi-leg journey. The processor computes the cost for each planned trip segment which will generally comprise one or more user-shortlisted transportation, accommodation, and sightseeing components. The processor preferably obtains real-time prices of these short-listed components in order to calculate the costs. For example, the real-time or last updated prices may be obtained from computer reservations systems (CRS), global distribution systems (GDS), other metasearch engines, directly from airline, hotel and sightseeing websites, and combinations thereof. In alternative embodiments, the prices may be updated at a specified frequency, or when a refresh is requested by the user (eg via the user device).

The processor then computes the total cost for the entire trip by summation of the individual trip segment costs. Preferably, the total trip cost is up to date as it comprises real-time prices for each of the user-shortlisted transportation, accommodation, and sightseeing components. The processor may then generate a timeline visualisation 60 of the planned trip itinerary comprising trip segments 62 and associated costs 64, and the total trip cost 66. This timeline visualisation may be displayed on the user device 2, as illustrated in FIG. 6. In some embodiments, this itinerary timeline visualisation may be integrated with social planning module 12, to assist a user with planning a trip.

The itinerary timeline visualisation 60 may further comprise a user interface control (not shown) to book one or more user-shortlisted transportation, accommodation, and sightseeing components. For example, the user may select the drop down buttons 68 to view details of each trip segment. In the detailed view, the user may be able to select a user interface control such as a button, checkbox, or hyperlink in order to book one or more of the shortlisted transportation, accommodation, and sightseeing components. In some embodiments, selecting the user interface control redirects the user to a booking webpage for each of the relevant transportation, accommodation, and sightseeing components, so that the user may conveniently place a booking. In other embodiments, user details such as contact details, credit card details, etc, stored by the server 4 may be transmitted to the relevant provider to automatically book the user-selected component. The booked transportation, accommodation, or sightseeing component may be indicated as such on the itinerary timeline visualisation 60, and/or may be added to the itinerary view of social planning module 12, as illustrated in FIG. 5a.

In some embodiments, the itinerary timeline visualisation 60 may further comprise a user interface control (not shown) to book all the user-shortlisted transportation, accommodation, and sightseeing components for a trip segment 62. Additionally or alternatively, the timeline visualisation 60 may comprise a user interface control (not shown) to book the entire trip. For example, user details stored by the server 4 may be transmitted to all the providers of the shortlisted components, to thereby automatically book all of the components for an entire trip segment or the entire trip. Alternatively, a notification may be sent to all of the providers of the shortlisted components to lock in the specified price, and booking details may subsequently be provided by the user to each provider.

In some embodiments, server 4 may transmit a notification to the user device 2 when an updated price is at or below a predetermined threshold price, such as a user-selected threshold price, or when a price is detected to be the lowest price since the trip itinerary was created. The price may be the price of a user-shortlisted transportation component, a user-shortlisted accommodation component, a user-shortlisted sightseeing component, a trip segment, or an entire trip. The notification may comprise a push notification, an in-app alert, short message service (SMS) message, an email or combinations thereof.

In light of the rapidly changing nature of travel-associated costs such as hotel room prices, airfares, and car rentals, the present itinerary timeline visualisation 60 provides the user with a convenient way to watch the prices of their shortlisted activities, and further, to keep an eye on the total cost of a trip segment and of the entire trip, to ensure that the planned trip remains within the user's budget. Additionally, embodiments of the invention allow the user to conveniently book one or more of their shortlisted activities, for example, promptly after being notified that a price they have been watching has dropped to within their budget. This allows the user to quickly and conveniently secure limited time offers such as heavily discounted airfares, with the confidence that the booking is not an impulse purchase, but that the booking works with their planned itinerary.

In some embodiments, the timeline visualisation 60 further comprises user interface controls 70a, 70b, 70c to add, modify and delete one or more of a user-shortlisted transportation component, a user-shortlisted accommodation component, a user-shortlisted sightseeing component, a trip segment, and an entire trip. The timeline visualisation 60 may be updated to reflect any changes when received and saved by the system.

In some embodiments, the processor may obtain alternative options to one or more of the user-shortlisted transportation, accommodation, and sightseeing components. The alternative options may comprise one or more of alternative dates, alternative times, and alternative providers to the user-shortlisted components, and may be obtained from computer reservations systems (CRS), global distribution systems (GDS), other metasearch engines, directly from airline, hotel and sightseeing websites, and combinations thereof. The alternative options and its associated costs may be displayed as suggestions on the timeline visualisation 60 for the relevant trip segment. The suggestions may comprise for example, a lower-cost alternative to the user-shortlisted component, or a higher value item such as a higher cabin class ticket that has been discounted to around the same price as the user-shortlisted airfare, or may be based on items booked by the user's friends, or may be based on the user's past trips logged with the system or on similar trips planned by other users of the social network-based system 100. In some embodiments, the timeline visualisation 60 may further comprise a user interface control (not shown) to book one or more of the alternative options.

In some embodiments, the processor is configured to optimise a trip segment or the entire trip, by suggesting one or more alternative options which result in a lower trip segment or trip cost respectively, compared to the user-planned itinerary. For example, in some embodiments, when the user selects the user interface control 72, the entire trip may be automatically optimised by the processor, by replacing one or more user-shortlisted components with one or more of the alternative options as described above. It should be appreciated that optimisation may not always be dependent on price; in some cases the user may wish to optimise convenience of the trip, for example, by reducing the number of connections or layovers of a flight.

Embodiments of the present invention provide social network-based systems and methods that are useful for assisting travellers with exploring trip ideas, planning a trip, and while travelling with a group.

For the purpose of this specification, the word “comprising” means “including but not limited to”, and the word “comprises” has a corresponding meaning.

The above embodiments have been described by way of example only and modifications are possible within the scope of the claims that follow.

1. A method, comprising:
receiving, by a processor, one or more of past, present, future, and planned locations of travellers within a social network, together with associated temporal data;
generating, by a or the processor, an interactive spatial visualisation of the locations of the travellers;
generating, by a or the processor, an interactive temporal visualisation of the temporal data; and
displaying the spatial and temporal visualisations on a user device;
wherein the spatial and temporal visualisations are synchronised such that user interaction of the temporal visualisation via the user device is reflected in corresponding changes in the spatial visualisation displayed.

2. The method of claim 1, wherein the spatial visualisation is a map and the location of each traveller is represented by a marker on the map.

3. The method of claim 1, wherein the spatial visualisation is a map and the number of travellers at a common location is represented by a marker on the map.

4. The method of claim 1, wherein the temporal visualisation is a timeline, and wherein the user interacts with the temporal visualisation by selecting a time point on the timeline.

5. The method of claim 4, wherein the user selects the time point by clicking on, tapping on, hovering on, or moving a slider element to the time point.

6. The method of claim 1, wherein the temporal visualisation further comprises visual representation of the amount of travel activity at one or more time points.

7. The method of claim 1, wherein user interaction of the spatial visualisation comprises one or more of zooming into the map, searching the map for a specific region or traveller, selecting a specific region or traveller to view additional information, and bookmarking a specific region.

8. A method, comprising:
receiving, by a processor, one or more of past, present, future, and planned locations of travellers within a social network, together with associated temporal data;
generating, by a or the processor, a Gantt chart visualisation of travel activity and/or locations of all the travellers within the social network across a specific time period; and
displaying the Gantt chart visualisation on a user device;
wherein each traveller is represented by a line of the Gantt chart and the time-varying travel activity and/or locations of the traveller are represented by markers on the line.

9. The method of claim 8, further comprising:
generating, by a or the processor, a spatial visualisation of the locations of the travellers; and
displaying the spatial visualisation on the user device.

10. The method of claim 8, wherein the spatial visualisation is a map and the locations and movement of each traveller are represented on the map by markers and arrows or lines respectively.

11. The method of claim 8, further comprising:
generating, by a or the processor, a spatial visualisation of the locations of the travellers; and
displaying the spatial visualisation on a user device;
wherein the spatial visualisation is synchronised with the Gantt chart visualisation such that user interaction of the Gantt chart visualisation via the user device is reflected in corresponding changes in the spatial visualisation displayed.

12. The method of claim 11, wherein the user interacts with the Gantt chart visualisation by clicking on, tapping on, hovering on, or moving a slider element to a time point to select the time point.

13. The method of claim 11, wherein the spatial visualisation is a map and the location of each traveller is represented by a marker on the map.

14. The method of claim 11, wherein the user device comprises a computer, a laptop, a tablet or a smartphone.

15. (canceled)

16. (canceled)

17. (canceled)

18. (canceled)

19. A method, comprising:
receiving, at a processor, a planned trip itinerary of a user comprising one or more trip segments;
computing, by the processor, costs for each trip segment comprising one or more user-shortlisted transportation, accommodation, and sightseeing components, wherein the user-shortlisted costs reflect real-time prices;
computing, by the processor, total cost for the entire trip comprising the sum of trip segment costs;
generating, by the processor, a timeline visualisation of the planned trip itinerary comprising trip segment costs and total trip cost; and
displaying the timeline visualisation on a user device, wherein the timeline visualization further comprises a user interface control to book one or more user-shortlisted transportation, accommodation, and sightseeing components; and
wherein selecting the user interface control redirects the user to a booking webpage for each of the relevant transportation, accommodation, and sightseeing components.

20. The method of claim 19, wherein the timeline visualisation further comprises a user interface control to book all the user-shortlisted transportation, accommodation, and sightseeing components for a trip segment.

21. The method of claim 19, wherein the timeline visualisation further comprises a user interface control to book all the user-shortlisted transportation, accommodation, and sightseeing components for the entire trip.

22. The method of claim 19, wherein the method further comprises:
updating, by the processor, costs for each of the user-shortlisted transportation, accommodation, and sightseeing components based on real-time prices obtained by the processor,
transmitting a notification to the user device when the real-time price of one or more of: a user-shortlisted transportation component, a user-shortlisted accommodation component, a user-shortlisted sightseeing component, a trip segment, and an entire trip, is at or below a user-selected threshold price.

23. The method of claim 19, wherein the timeline visualisation further comprises user interface controls to add, modify and delete one or more of: a user-shortlisted transportation component, a user-shortlisted accommodation component, a user-shortlisted sightseeing component, a trip segment, and an entire trip, and wherein the timeline visualisation is updated to reflect said changes.

24. The method of claim 19, wherein the method further comprises:
obtaining, by the processor, alternative option(s) to one or more of the user-shortlisted transportation, accommodation, and sightseeing components,
displaying, on the timeline visualisation, the alternative options and associated costs.

25. The method of claim 24, wherein the alternative options comprise one or more of alternative dates, alternative times, and alternative providers to the user-shortlisted components.

26. The method of claim 24, further comprising computing, by the processor, optimised trip segment(s) comprising one or more alternative options resulting in lower trip segment cost(s) compared to the user-shortlisted trip segment.

27. The method of claim 24, wherein the timeline visualisation further comprises a user interface control to book one or more of the alternative options.

28. (canceled)

29. (canceled)

30. The method of claim 1, further comprising:
generating, by a or the processor, an interactive leaderboard visualisation of the travellers ranked by number of past locations of each traveller,
displaying the leaderboard visualisation on the user device.

31. The method of claim 30, wherein user selection of a traveller displayed on the leaderboard visualisation generates a spatial and/or temporal visualisation display of the locations of the selected traveller.

32. (canceled)

33. (canceled)
